(19) United States
(12) Patent Application Publication
(10) Pub. No.: US 2015/0318536 A1
(43) Pub. Date: Nov. 5, 2015

(54) PRODUCTION OF A MATERIAL BASED ON LI4TI5O12 WITH MILLING IN THE PRESENCE OF CARBON

(71) Applicant: RENAULT s.a.s., Boulogne-Billancourt (FR)

(72) Inventors: Edgard NGABOYAMAHINA, Grenoble (FR); Cedric HAON, Grenoble (FR)

(73) Assignee: RENAULT s.a.s., Boulogne-Billancourt (FR)

(21) Appl. No.: 14/361,147

(22) PCT Filed: Nov. 23, 2012
(86) PCT No.: PCT/EP2012/073486

§ 371 Date: May 28, 2014

(30) Foreign Application Priority Data
Nov. 28, 2011 (FR) 1160847

(51) Int. Cl. H01M 4/131; H01M 4/485; H01M 4/40; H01M 4/62; H01M 4/134

(52) U.S. Cl. CPC H01M 4/131; H01M 4/623; H01M 4/134; H01M 4/625; H01M 4/405; H01M 4/485; H01M 2004/027

(57) ABSTRACT

A process for producing a material based on Li₄Ti₅O₁₂, comprising a step of synthesizing particles of Li₄Ti₅O₁₂, comprises a step of milling the particles resulting from the synthesis step, carried out in the presence of graphite carbon. The invention also relates to a material based on Li₄Ti₅O₁₂ obtained by this production process, and to various uses of this material in the context of an electrode for an electrochemical generator.

### TECHNICAL AREA OF THE INVENTION

The invention relates to the area of lithium electrochemical generators having an electrode, notably an anode, including a material based on Li₄Ti₅O₁₂.

The invention relates more particularly to a process for producing such a material, as well as a material as such, an electrode and an electrochemical generator.

### PRIOR ART

The general area of the invention relates to lithium electrochemical generators. These electrochemical generators function conventionally on the principle of insertion or deinsertion (also called “intercalation” and “deintercalation”) of lithium on at least one electrode. Consequently the size of the particles constituting the electrode material plays a major role in facilitating diffusion of the lithium ions to the sites where the reactions take place.

A material based on titanium oxide spinel Li₄Ti₅O₁₂ is of considerable interest for power applications, notably for inclusion in the constitution of the negative electrode (anode) for lithium secondary batteries. Its structure remains unchanged during the charge/discharge cycles, which guarantees a long service life of the battery. Its electric potential is higher by the order of 1.5V than that of reduction of the various solvents employed; therefore a solid-electrolyte interface (SEI) does not form. Its theoretical specific capacity is 175 mAh/g cycled between 1V and 2V. The insertion reaction is written as follows:

Li₄Ti₅O₁₂+3Li⁺+3e⁻ [symbol] Li₇Ti₅O₁₂

Production of such a material based on Li₄Ti₅O₁₂ comprises synthesis of pure crystalline particles of Li₄Ti₅O₁₂, which at present may be done in two steps:
mixing of precursors by milling, such as titanium dioxide TiO₂ with lithium carbonate Li₂CO₃ or lithium hydroxide LiOH,
and calcination of the mixture obtained, between 700° C. and 900° C.

The first step allows intimate mixing of the precursors and, by reducing their sizes, makes it possible to reduce the diffusion distances. This then makes it possible to reduce the duration and optionally the calcination temperature.

In a known manner, once synthesized, the lithiated titanium oxide powder may be milled again and then optionally treated thermally at a temperature below the calcination temperature. This post-treatment then improves the performance of the material under extreme cycling conditions. This milling allows refining of the size of the particles synthesized.

One of the major problems encountered during milling for mass production is clogging of the powder within the grinding mills and on the grinding media, with a consequent drop in efficiency and production of non-uniform batches.

Thus, document US2008/028521 1A1 discloses a method of synthesis of Li₄Ti₅O₁₂ by ternary mixing of Li₂CO₃, TiO₂ and carbon. According to the document, the carbon reacts with the oxygen derived from TiO₂ and thus facilitates reaction of Ti with lithium to form lithiated titanium, which is then oxidized by the air. This makes it possible to lower the temperature at which the spinel structure forms.

Nevertheless, to attain performance that is of interest from an industrial standpoint, milling to reduce the size of the Li₄Ti₅O₁₂ particles thus synthesized remains obligatory, but this document US2008/028521 1A1 remains silent regarding solutions for making it possible to:
avoid clogging during milling as far as possible,
simplify discharging of the powders resulting from milling,
improve the homogeneity of the powders resulting from milling,
improve the electrochemical performance of the powders resulting from milling, and the reproducibility of said performance.

### AIM OF THE INVENTION

The aim of the present invention is to propose a solution for obtaining a material based on Li₄Ti₅O₁₂ that overcomes the drawbacks listed above.

A first aim of the invention is to provide a production process that reduces or even eliminates clogging during the operation of milling of the particles of Li₄Ti₅O₁₂ resulting from their synthesis.

A second aim of the invention is to provide a production process that makes it possible to simplify discharging of the powders resulting from milling of the particles of Li₄Ti₅O₁₂ previously synthesized.

A third aim of the invention is to provide a production process that makes it possible to improve the homogeneity of the powders resulting from milling of the particles of Li₄Ti₅O₁₂ previously synthesized.

A fourth aim of the invention is to provide a production process that makes it possible to improve the electrochemical performance of the powders resulting from milling of the particles of Li₄Ti₅O₁₂ previously synthesized.

A fifth aim of the invention is to provide a production process that makes it possible to improve the reproducibility of the electrochemical performance of the powders resulting from milling of the particles of Li₄Ti₅O₁₂ previously synthesized.

A first aspect of the invention relates to a process for producing a material based on Li₄Ti₅O₁₂, comprising a step of synthesis of particles of Li₄Ti₅O₁₂. It comprises a step of milling of the particles obtained from the synthesis step, carried out in the presence of graphitic carbon.

The graphitic carbon may have a specific surface between 1 and 10 m²/g, advantageously of the order of 3 m²/g.

The proportion by weight of carbon during the milling step may be within a range between 0.1% and 2%, notably is below 0.7%, for example is of the order of 0.5%.

The milling time may be between about 1 h and 100 h, preferably between 10 h and 80 h.

The milling step may comprise at least one step of unclogging of the particles during milling, notably applicable periodically in the course of the milling step.

During the milling step, grinding media such as steel balls may be mixed with the particles obtained from the synthesis step and the carbon according to a grinding media/powders volume ratio between 4 and 12.

The process may comprise a step of thermal treatment applied to the particles obtained from the milling step.

The synthesis step may comprise a step of mixing precursors such as Li₂CO₃, LiOH, TiO₂, and a step of calcination of the particles obtained from the mixing step.

A second aspect of the invention relates to a material based on Li₄Ti₅O₁₂ obtained by said production process.

A third aspect of the invention relates to an electrode for an electrochemical generator, notably an anode, comprising at least one such material based on Li₄Ti₅O₁₂. It may comprise carbon black and polyvinylidene fluoride.

A fourth aspect of the invention relates to an electrochemical generator comprising at least one such electrode. It may comprise a sheet of lithium as counter-electrode and/or reference electrode.

### BRIEF DESCRIPTION OF THE DRAWINGS

Other advantages and features will become clearer from the following description of particular embodiments of the invention given as nonlimiting examples and shown in the appended drawings, in which:

FIG. 1 shows the evolution of clogging during remilling in 2 L drums (balls/powder volume ratio=5) without carbon, with a 320 g batch of Li₄Ti₅O₁₂ and complete unclogging every 10 h,

FIG. 2 shows the evolution of clogging during remilling in 2 L drums (balls/powder volume ratio=5) in the presence of graphitic carbon, with a 320 g batch of Li₄Ti₅O₁₂ and complete unclogging every 10 h,

FIG. 3 shows the evolution of clogging during remilling in 2 L drums (balls/powder volume ratio=5) for different amounts of graphitic carbon (0-0.5% -5% -10%), with a 320 g batch of Li₄Ti₅O₁₂ and complete unclogging at 40 h and 80 h,

FIG. 4 illustrates the curve representing specific capacity in mAh/g as a function of the current density in mA/cm² in the case of galvanostatic cycling in a button cell on Li₄Ti₅O₁₂ remilled for 40 h (unclogging every 10 h, with graphitic carbon (top curve) and without graphitic carbon (bottom curve) respectively),

and FIG. 5 illustrates the mean specific capacity in mAh/g (and standard deviation) as a function of the current density in mA/cm² based on powders remilled for 80 h with carbon (top curve) and without carbon (bottom curve).

### DESCRIPTION OF PREFERRED EMBODIMENTS OF THE INVENTION

As is known, production of a material based on Li₄Ti₅O₁₂ (the advantages of which are notably a constant structure during the charge/discharge cycles favoring the overall service life, a fairly high electric potential and its high specific capacity) comprises a step of synthesis of pure crystalline particles of Li₄Ti₅O₁₂ in two steps:
mixing of precursors for example by milling, such as titanium dioxide TiO₂ with lithium carbonate Li₂CO₃ or lithium hydroxide LiOH,
and calcination of the particles (powders) obtained from the mixing step, for example by means of a temperature rise between about 700° C. and 900° C.

The decrease in size of the particles resulting from the intimate mixing of the precursors reduces the diffusion distances. This then allows reduction of the calcination time and optionally the calcination temperature.

Preferably, according to the invention, the TiO₂ is of the anatase type, more preferably it has a grain size between 0.1 μιτι and 3 μιτι. The average diameter of the particles of TiO₂ is preferably between 0.2 μηη and 0.6 μηη, advantageously of the order of 0.4 μηη.

As is known, lithiated titanium oxide thus synthesized may be milled. This step, consisting of milling of the particles previously synthesized, i.e. obtained from the synthesis step described above, makes it possible to refine the size of the particles synthesized.

One of the major problems encountered during milling of the particles obtained from the synthesis step, for mass production, is the phenomenon of clogging of the powder within the grinding mills and on the grinding media, with a consequent drop in efficiency and production of non-uniform batches.

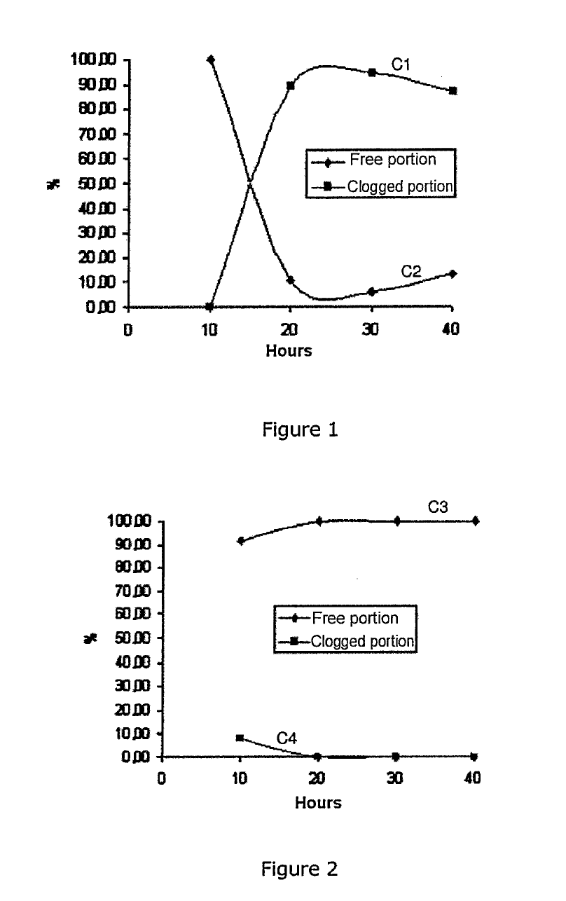

FIG. 1 shows an example of this phenomenon, illustrating the evolution of clogging during post-synthesis milling in two-liter drums (balls/powder volume ratio equal to 5) without presence of carbon, of a 320 g batch of Li₄Ti₅O₁₂ with complete unclogging every 10 h of milling. Curve C1 passing through the squares corresponds to the portion or fraction of powder that is clogged. Curve C2 passing through the diamonds corresponds to the portion or fraction of powder that is free, i.e. not clogged. Thus, for milling without carbon, beyond 20 h, the free portion barely exceeds 10% of the total powder, which is of course rather unsatisfactory for the reasons given above.

The invention is based on the surprising and unexpected finding that was made, that the process for producing a material based on Li₄Ti₅O₁₂, comprising firstly said step of synthesis of particles of Li₄Ti₅O₁₂, could advantageously be supplemented with a step of milling of the particles obtained from the synthesis step, said milling being carried out in the presence of carbon, to respond to the problems posed by the prior art. Notably, it is very practical to use a grinding agent comprising carbon. Very good results were obtained with carbon in the form of graphite, for example following a time of application of milling between 1 h and 100 h, preferably between about 10 h and 80 h.

The carbon of the graphite type used according to the invention advantageously has a specific surface (BET) between 1 and 10 m²/g, advantageously of the order of 3 m²/g. Preferably, the graphitic carbon used according to the invention is in the form of grains with a size between 1 and 20 μηη.

The proportion by weight of carbon during the milling step must be within a range between 0.1% and 2%, notably remaining below 0.7%. In practice, a proportion by weight of the order of 0.5% gives very good results. In fact, it was found that the higher the proportion of carbon, beyond the values stated above, the more the clogging increases. This is due to the hygroscopic properties of graphitic carbon, which oppose its lubricating properties.

Advantageously, the step of milling of the particles previously synthesized may, but does not have to, comprise at least one step of unclogging of the particles during milling, notably applicable periodically during milling, for example according to a period between about 10 h and 20 h.

To improve effectiveness and the effects of milling, grinding media such as steel balls are mixed with the powders formed from the particles obtained from the synthesis step and the carbon, according to a grinding media/powders volume ratio between 4 and 12, for example.

Finally, the process may comprise a step of thermal treatment applied to the particles obtained from the milling step, of short duration, notably at a temperature below that used during the calcination envisaged in the synthesis step. Such a post-treatment further improves the performance of the material under extreme cycling conditions.

It should be noted that the graphitic carbon does not serve as a coating of the electrochemical grains and does not contribute to the conductivity in the material.

Advantageously, the graphitic carbon is partially, or even completely, removed by thermal treatment under air or under oxidizing atmosphere for from 15 minutes to 8 hours, preferably less than 1 hour at a temperature between 500 and 600° C.

Application of the process described above makes it easy to obtain a material based on Li₄Ti₅O₁₂ of very high quality, which may notably serve for the manufacture of an electrode for an electrochemical generator, notably an anode. This electrode may in fact comprise a mixture of material based on Li₄Ti₅O₁₂ obtained by the process described above, with carbon black as electronic conductor and a binder such as polyvinylidene fluoride. Such an electrode may then be included in the composition of an electrochemical generator further comprising, optionally, a sheet of lithium as counter-electrode and/or reference electrode.

The general principles described above will be better understood by virtue of the following three examples, which will moreover make it possible to show that the solution described makes it possible to:
reduce or even eliminate clogging during the operation of milling of the particles of Li₄Ti₅O₁₂ after their synthesis,
improve the homogeneity of the powders resulting from milling of the particles of Li₄Ti₅O₁₂ previously synthesized,
improve the electrochemical performance of the powders resulting from milling of the particles of Li₄Ti₅O₁₂ previously synthesized,
improve the reproducibility of the electrochemical performance of these powders,
and simplify discharging of the powders resulting from milling of the particles of Li₄Ti₅O₁₂ previously synthesized.

In a first example, two 2-liter polypropylene drums were each filled with 320 g of Li₄Ti₅O₁₂ and 3.6 kg of steel balls having a diameter of 8.732 mm. The degree of filling is therefore 40%. The balls/powder volume ratio is equal to 5. One of the drums contained, in addition to Li₄Ti₅O₁₂, a small amount of graphitic carbon (0.5% of the weight of Li₄Ti₅O₁₂). The two drums were placed on a rotary drum grinder at a speed of 130 rev/min for 40 h, with complete unclogging every 10 h. At the moment of unclogging, samples were taken from the free and clogged portions of each drum for their characterization. The amounts taken only had a very slight effect on the resultant volume ratio. The results obtained show the influence of carbon. In fact, at each discharging beyond 20 h, the free portion of the drum containing graphitic carbon represented the whole of the dischargeable powder, further facilitating the discharging and in general the application of the post-synthesis milling.

FIG. 2 illustrates this result, thus showing that after an application time of the milling step greater than 20 h, the proportion of unclogged particles within the particles during milling is between 50% and 100%, or even is above at least 90%: curve C3 passing through the diamonds (representing the portion or fraction of powder during milling that is free, i.e. not clogged) is well above 90% beyond a milling time of 20 h (time being represented on the abscissa). Curve C4 passing through the squares, for its part, represents the portion or fraction of powder during milling that is clogged, this curve approaching 0% starting from 20 h of milling.

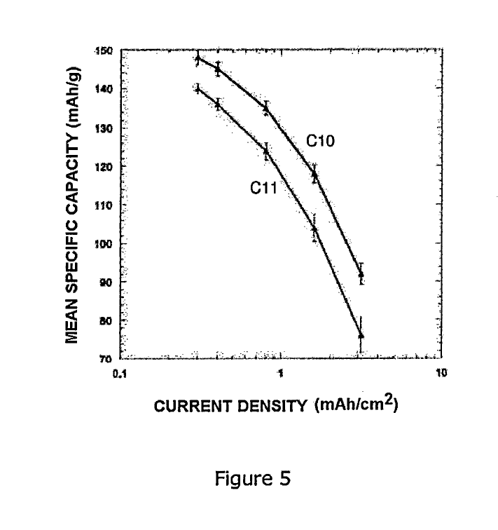

Electrochemical tests carried out on these particles obtained from post-synthesis milling show a clear improvement in specific capacity under extreme conditions of charging and discharging in the case of milling in the presence of graphitic carbon, notably of the order of 50% improvement. This is due in large part to the fluidization of the bed of powder during the post-synthesis milling, which allows an improvement in the effectiveness of milling. FIG. 4 shows this result (current density on the abscissa, specific capacity on the ordinate), curve C5 (corresponding to the case of milling in the presence of carbon) is about 50% higher than curve C6 (corresponding to the case of milling without carbon), in densities above 1 mA/cm².

In the second example, corresponding to the same conditions as the example described above, four milling tests were carried out with different proportions of graphitic carbon (0%, 0.5%, 5% and 10% respectively). The milling step was carried out for 80 h with unclogging and complete discharging after an intermediate time of 40 h. It is found that the amount of carbon used has an influence on the clogging of Li₄Ti₅O₁₂. In fact, for proportions of carbon of 5 and 10%, the degree of clogging is greater than 90%, as in the case of milling without presence of carbon. In contrast, the use of 0.5% of carbon makes it possible to recover almost the whole of the powder in free form avoiding a maximum of clogging.

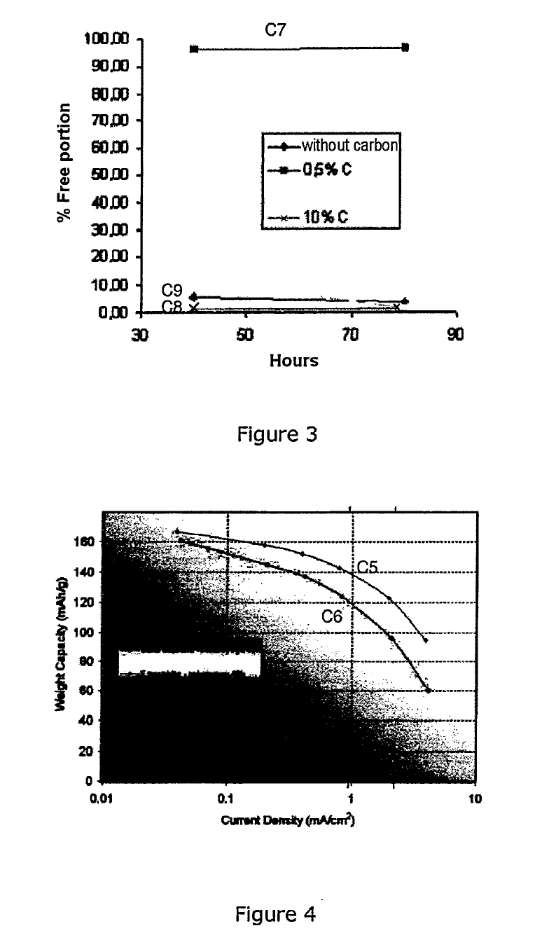

FIG. 3 shows that the fraction of unclogged particles is above 90% for the case of a proportion by weight of carbon of 0.5% (curve C7 passing through the squares), whereas it becomes close to 1% for the case of a proportion by weight of carbon of 10% (curve C8 passing through the crosses), becoming even lower than the case corresponding to absence of carbon (curve C9 passing through the diamonds).

The third example corresponds to the same conditions as the two examples described previously, with two batches of Li₄Ti₅O₁₂ milled post-synthesis for 40 h with unclogging every 10 h. A first batch contained 0.5% by weight of carbon relative to the weight of Li₄Ti₅O₁₂ and a second batch did not contain any grinding agent, milling thus being carried out without the presence of carbon. At the end of milling, three samples were taken from each batch. They were then tested electrochemically according to a procedure equivalent to that of the first example.

From each batch, two button cells were produced in order to be sure of the homogeneity of the batches. It was found, firstly, that the use of carbon during post-synthesis milling has a positive influence on electrochemical performance. All of the results are of the type shown in FIG. 4.

This improvement in performance is accompanied, moreover, by better reproducibility and therefore smaller standard deviations notably under extreme cycling conditions.

The following table presents a synopsis of the values of the mean capacities and corresponding standard deviations for each cycling condition.

| | | | Mean | Standard |
|---|---|---|---|---|
| | Mean | Standard | capacity | deviation |
| | capacity | deviation | Remilling | Remilling |
| | Remilling | Remilling | without | without |
| CONDITION | with carbon | with carbon | carbon | carbon |
| (mAh/cm²) | (mAh/g) | (mAh/g) | (mAh/g) | (mAh/g) |
| 0.300 | 148 | 1.9 | 140 | 1.2 |
| 0.400 | 145 | 1.8 | 136 | 1.5 |
| 0.800 | 135 | 1.7 | 124 | 2.2 |
| 1.600 | 118 | 2.3 | 104 | 3.5 |
| 3.150 | 92 | 2.7 | 76 | 4.5 |

FIG. 5 gives details of a comparison and the reproducibility of the electrochemical performance of electrodes made from powders milled post-synthesis with and without carbon, for 80 hours. Curves C10 and C11 represent the mean specific capacity as a function of the current density, the top curve C10 and the bottom curve C11 corresponding respectively to the cases of milling post-synthesis in the presence of carbon and without carbon. It is thus found that the values of the specific capacities of the different cells tested have less dispersion in the case of milling in the presence of carbon.

It should be pointed out that all the electrochemical tests were carried out with button cells. The working electrode was made from a mixture of the active material Li₄Ti₅O₁₂, carbon black as electronic conductor and polyvinylidene fluoride (PVDF) as binder, the whole in a proportion by weight of 80%, 10% and 10% respectively. A sheet of lithium served as counter-electrode and reference electrode.

Photographs obtained with a field-effect electron microscope, on batches of Li₄Ti₅O₁₂ milled post-synthesis for 40 h with unclogging every 10 h, show the formation of agglomerates for the case of milling without carbon and a uniform size of the particles for the case of milling in the presence of carbon.

The invention finally relates to a device for producing a material based on Li₄Ti₅O₁₂ that comprises software and/or appropriate equipment for carrying out the production process described above.

1. A process for producing a material based on Li₄Ti₅O₁₂, comprising:
a step of synthesizing particles of Li₄Ti₅O₁₂,
a step of milling the particles obtained from the synthesis step, said milling being carried out in the presence of graphitic carbon.

2. The process for producing a material based on Li₄Ti₅O₁₂ as claimed in claim 1, wherein the graphitic carbon has a specific surface between 1 and 10 m²/g, advantageously of the order of 3 m²/g.

3. The process for producing a material based on Li₄Ti₅O₁₂ as claimed in claim 1, wherein the proportion by weight of carbon during the milling step is within a range between 0.1% and 2%.

4. The process for producing a material based on Li₄Ti₅O₁₂ as claimed in claim 3, wherein the proportion by weight of carbon during the milling step is below 0.7%.

5. The process for producing a material based on Li₄Ti₅O₁₂ as claimed in claim 4, wherein the proportion by weight of carbon during the milling step is of the order of 0.5%.

6. The process for producing a material based on Li₄Ti₅O₁₂ as claimed in claim 1, wherein the milling time is between about 1 h and 100 h, preferably between 10 h and 80 h.

7. The process for producing a material based on Li₄Ti₅O₁₂ as claimed in claim 1, wherein the milling step comprises at least one step of unclogging of the particles during milling, applicable periodically in the course of the milling step.

8. The process for producing a material based on Li₄Ti₅O₁₂ as claimed in claim 1, wherein during the milling step, grinding media such as steel balls are mixed with the particles obtained from the synthesis step and the carbon according to a grinding media/powders volume ratio between 4 and 12.

9. The process for producing a material based on Li₄Ti₅O₁₂ as claimed in claim 1, further comprising a step of thermal treatment applied to the particles obtained from the milling step.

10. The process for producing a material based on Li₄Ti₅O₁₂ as claimed in claim 1, wherein the synthesis step comprises a step of mixing precursors such as Li₂CO₃, LiOH, TiO₂, and a step of calcination of the particles obtained from the mixing step.

11. A material based on Li₄Ti₅O₁₂ obtained by the production process as claimed in claim 1.

12. An electrode for an electrochemical generator, notably anode, comprising at least one material based on Li₄Ti₅O₁₂ as claimed in claim 11.

13. The electrode as claimed in claim 12, comprising carbon black and polyvinylidene fluoride.

14. An electrochemical generator comprising at least one electrode as claimed in claim 12.

15. The electrochemical generator as claimed in claim 14, comprising a sheet of lithium as counter-electrode and/or reference electrode.
